(19) United States
(12) Patent Application Publication
(10) Pub. No.: US 2014/0006142 A1
(43) Pub. Date: Jan. 2, 2014

(54) Distribution of Digital Content Via Community Networking Systems

(71) Applicants: Glenn Gaudet, Arlington, MA (US); Jason Nochlin, Somerville, MA (US)

(72) Inventors: Glenn Gaudet, Arlington, MA (US); Jason Nochlin, Somerville, MA (US)

(73) Assignee: GaggleAMP, Inc., Cambridge, MA (US)

(21) Appl. No.: 13/709,826

(22) Filed: Dec. 10, 2012

Related U.S. Application Data
(60) Provisional application No. 61/586,178, filed on Jan. 13, 2012.

(51) Int. Cl. G06Q 50/00; G06Q 30/02

(52) U.S. Cl. CPC G06Q 50/01; G06Q 30/0246
USPC 705/14.45

(57) ABSTRACT

Described herein are systems, services, and methods for identifying a message for sharing with a number of members of an organization, distributing, to each member of the number of members, an offer to share the message, receiving, responsive to the offer to share, from at least a portion of the number of members, a respective authorization to share the message via a networking community, and causing issuance of the message via the networking community on behalf of each member of the portion of the number of members. After causing issuance of the message, an indication of one or more engagements with the message may be received, and collected information regarding the one or more engagements may be stored. The collected information may be used in preparing a report including the collected information regarding the one or more engagements, and providing the report for review by the organization.

### RELATED APPLICATIONS

The present application claims priority to U.S. Provisional Application No. 61/586,178 entitled “Distribution of Digital Content Via Community Networking Systems” and filed Jan. 13, 2012, the contents of which are hereby incorporated by reference in its entirety.

### BACKGROUND

Networking communities provide a member of the community the opportunity to share information with other members of the community. Examples of networking communities include dating networks, medical community networks, discrete content user networks, publication and content driven networks, fundraising networks, issue-oriented networks, political networks, professional networks, and other networks where information is distributed between a group of members. A popular segment of networking communities are social media networks, where information is shared between a member and the member's followers (e.g., friends). Examples of social media networks include Facebook™ by Facebook, Inc. of Menlo Park, Calif., Google+™ by Google Inc. of Mountain View, Calif., Twitter™ by Twitter, Inc. of San Francisco, Calif., and LinkedIn™ by LinkedIn Corporation of Mountain View, Calif.

Social media marketing often involves presenting materials (e.g., messages, posts, etc.) with the goal of having the materials shared organically through social media networking. For example, a member of a social media network may promote an organization or other entity by engaging with the organization or entity in a manner that is visible to the followers (e.g., friends, peers, subscribers, etc.) of the member of the social media network. In some examples, expressing approval (e.g., “Like”) of a social media message posted by an entity, copying (e.g., re-posting, retweeting, etc.) a social media message posted by an entity, posting a comment regarding a social media message posted by an entity, or posting information referred to within a social media message posted by an entity (e.g., a uniform resource locator (URL) to a web page for information regarding a new product or campaign, etc.) can be considered engaging with the entity in a manner that is visible to followers.

### SUMMARY

In some implementations, a system for amplifying the distribution of information posts among members of one or more virtual communities may include a mechanism for an organization to use followers, fans, employees, or other interested individuals to distribute information on behalf of the organization. The individuals who join the system on behalf of the organization, for example, may have authorized the collection of personal and activity data associated with each respective individual. In some implementations, one or both of the personal and activity data may be collected on a specific community networking (e.g., social media) system. As a result, the system for amplifying the distribution of information posts may collect the data (e.g., from each individual community networking system), aggregate, analyze and report on a variety of data components. In this manner, the originator of the amplified content (e.g., the central organization, entity, or individual) may be provided with insights on which to make future decisions and improve the performance of this process. The system may use the data, in some implementations, in aggregate or at the individual level based on the desired reporting needs. As a result, the system can be quite useful in data collection and analytics whether or not the central organization or person actively invites members to act as a distribution mechanism.

The system, in some implementations, can provide rich analytics to both the central organization as well as the person that joins the construct. The system may track the messages not just sent via the system, but all messages that the members are creating, sharing and interacting with on the of the one or more community networking systems. The connection point between an individual and a particular community networking system, in some implementations, may be referred to as a user account. In some implementations, user accounts may be affiliated with or connected to the system for amplifying the distribution of information posts. For example, user account data may become part of the aggregate or individually reported on data. Examples of data collected and or reported on may include one or more of the following: Message; Message Behavior; Demographics; Message components including links (URLs), video & audio; Account information; and Personal information.

According to some embodiments of the present disclosure, a method includes identifying, by a processor of a computing device, a message for sharing with a number of members of an organization, where the message is associated with the organization. The method may include distributing, by the processor, to each member of the number of members, an offer to share the message, and receiving, by the processor, responsive to the offer to share, from at least a portion of the number of members, a respective authorization to share the message via a networking community. The method may include causing, by the processor, issuance of the message via the networking community on behalf of each member of the portion of the number of members, and, after causing issuance of the message, receiving, by the processor, an indication of one or more engagements with the message. The method may include storing, by the processor, collected information regarding the one or more engagements, where the collected information regarding the one or more engagements includes one or more of a timestamp, a region, a networking community, a networking community account identifier, and text content of the engagement. The method may include preparing, by the processor, a report including the collected information regarding the one or more engagements, and providing the report for review by the organization.

In some embodiments, each engagement of the one or more engagements includes one or more of a click-through, a re-post, a share, a like, a retweet, and a comment referencing the message, and each engagement of the one or more engagements is associated with an individual not included in the portion of the number of members. In some embodiments, the click-through includes access to a customized link to a web page.

In some embodiments, causing issuance of the message includes distributing the message via a networking community application programming interface. Distributing the offer to share may include posting information to one or more members of the number of members via the networking community.

In some embodiments, causing issuance of the message may include scheduling the message for issuance using a scheduling algorithm, where the scheduling algorithm is based in part upon historical analysis of message sharing. Scheduling the message may include scheduling the message to issue at a first time for a first group of the portion of the number of members, and scheduling the message to issue at a second time for a second group of the portion of the number of members. The method may further include identifying, based in part upon the collected information, one or more time periods most prevalent for engagement of messages, and updating the scheduling algorithm according to the one or more time periods. Identifying the one or more time periods may further include identifying one or more time periods per day.

In some embodiments, receiving the indication of one or more engagements of the message includes receiving indication of one or more engagements of the message as issued on behalf of a particular member of the number of members, where the method further includes, responsive to receiving the indication of one or more engagements of the message as issued on behalf of the particular member, crediting an account associated with the particular member with a number of engagements.

In some embodiments, the method includes storing collected information regarding authorizations to share, where the method further includes, prior to distributing the message, scheduling the message for distribution, where the message is scheduled based upon a distribution algorithm, where the distribution algorithm is based in part upon prior collected information regarding authorizations to share. The method may further include identifying, based in part upon the collected information regarding authorizations to share, one or more time periods most prevalent for sharing messages, and updating the distribution algorithm according to the one or more time periods most prevalent for sharing messages.

According to some embodiments of the present disclosure, a system includes a processor and a memory having instructions stored thereon, where the instructions, when executed by the processor, cause the processor to retrieve, from a network account associated with an organization, a number of messages, identify, within the number of messages, a first message for distribution to a number of members of the organization, and distribute, to each member of the number of members, an offer to share the message via one or more networking community accounts associated with the respective member. The instructions may cause the processor to receive, responsive to the offer to share, from at least a portion of the number of members, a respective authorization to share the message, where the respective authorization identifies at least one of the one or more respective networking community accounts. For each member of the portion of the number of members, the instructions may cause the processor to cause issuance of the message via the respective at least one of the one or more respective networking community accounts. After causing issuance of the message, the instructions may cause the processor to collect information related to the distribution of the message, where the information is collected via application programming interfaces provided by one or more networking community entities associated with the respective networking community accounts. The instructions may cause the processor to determine statistical information regarding the information related to the distribution of the message.

In some embodiments, identifying the first message includes identifying, within the first message, a predetermined mark. The predetermined mark may include a hashtag.

In some embodiments, identifying the first message includes filtering the number of messages to identify a portion of the number of messages containing content originated by the organization. Identifying the first message may further include filtering the number of messages to remove messages identified by a predetermined criteria.

In some embodiments, the network account includes one of a social media account, RSS feed, and blog feed.

According to some embodiments of the present disclosure, a non-transitory computer readable medium has instructions stored thereon, where the instructions, when executed by a processor, cause the processor to identify a message for distribution to a number of members of an organization, where the message is associated with the organization, distribute, to each member of the number of members, an offer to share the message via one or more social media accounts associated with the respective member, and receive, responsive to the offer to share, from at least a portion of the number of members, a respective authorization to share the message, where the respective authorization identifies at least one of the one or more respective social media accounts.

In some embodiments, for each member of the portion of the number of members, the instructions cause the processor to cause issuance of the message via the respective at least one of the one or more respective social media accounts. After causing issuance of the message, the instructions may cause the processor to receive a number of indications of engagements of the message, where at least a portion of the number of indications of engagements includes a member identifier. The instructions may cause the processor to determine information regarding the engagements of the message, where the information regarding the engagements of the message includes one or more of a timestamp, a region, and a networking community, a networking community account identifier, and text content of the engagement, and the information regarding the engagements of the message is made available for review by the organization. The instructions may cause the processor to, for each respective member identifier, credit an account with the respective number of engagements.

In some embodiments, the instructions further cause the processor to receive, from a first member of the portion of the number of members, responsive to the offer to share, a customized version of the message, where causing issuance of the message includes causing issuance of the customized message. The instructions may further cause the processor to, prior to receiving the customized version of the message, determine permission settings of the first member, and provide, based in part upon the permission settings of the first member, an interactive dialogue including the message, where the first member amends or alters the first message within the interactive dialogue.

### BRIEF DESCRIPTION OF THE FIGURES

The foregoing and other objects, aspects, features, and advantages of the invention will become more apparent and may be better understood by referring to the following description taken in conjunction with the accompanying drawings, in which:

FIG. 1 is a diagram of example data relationships involved in message distribution via community networking systems;

FIG. 2 is a diagram of example methods for distributing messages to community networking systems;

FIG. 3 is a flow chart of an example method for traversing message sharing options;

FIG. 4 is a diagram of example data relationships for member information and community networking system interactions of the present system;

FIG. 5 is a block diagram of an example network environment for distributing messages via community networking systems;

FIG. 6 is a block diagram of a computing device and a mobile computing device;

FIG. 7 is a flow chart of an example method for distributing messages via community networking;

FIG. 8 is an example of an interface for sharing messages;

FIGS. 9A and 9B are example activity reports illustrating amplification data regarding messages distributed using a community networking system;

FIGS. 10A and 10B are example graphs illustrating member behavior of members in a community networking system;

FIG. 11 is an example report illustrating aggregated data collected from multiple community networking system accounts regarding multiple messages;

FIG. 12 is an example report regarding a particular message;

FIG. 13 illustrates example report data illustrating changes in participation of members in a community networking system; and

FIG. 14 is an example timing report illustrating sharing activity based upon share time.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

In some implementations, a system and service for distributing digital information posts (e.g., including one or more of text, graphic, audio, and video data) may include a number of methods that allow a central organization or individual to create and distribute a variety of message types allowing a community of people to share the centrally distributed messages in a manner that may provide the opportunity to aggregate, analyze and report on message behavior, community demographics and other community and individual based network interactions. The networks described may include, in some examples, social media networks, collaboration networks and other communities and applications that group people together and collect any personal information, messages, message dynamics and/or interactions by one or more components of the network. In some examples, networking communities may include one or more of dating networks, medical community networks, discrete content user networks, publication and content driven networks, fundraising networks, issue-oriented networks, political networks, and other networks where information is distributed among a group of members.

A system for distributing electronic messages, in some implementations, may enable an organization or an individual to invite a number of people into a group construct that allows the people to share social media messages of the organization or individual. The use of such a system, in some implementations, may provide the benefit of an amplification effect of an individual message. For example, when a person shares a message with contacts established within a personal social media network, the number of potential people having the opportunity to see that message may increase significantly with each share (e.g., post, re-post, retweet, linking of information, “like”, share, etc.). The result has the potential of exponentially increasing the reach of any message that is distributed via the system. When an organization or individual shares a message with members within a system for distributing electronic messages, for example, the members (e.g., friends, contacts, business associates, employees, affiliates, etc.) in turn share the message on one or more social networks, allowing followers (e.g., socially networked individuals) of each of the members the opportunity to review the message. The potential audience for a particular member may be expressed as members (of the system for distributing electronic messages), friends (related to members via social media), and followers (friends of friends or others who, through the chain of sharing, come into contact with the message originating from an organization or individual). The number of generations of potential followers (e.g., degrees of separation from the initial sharer of the message) is unlimited. The system, in some implementations, may allow for an award program to be used as part of the incentive to share information posts.

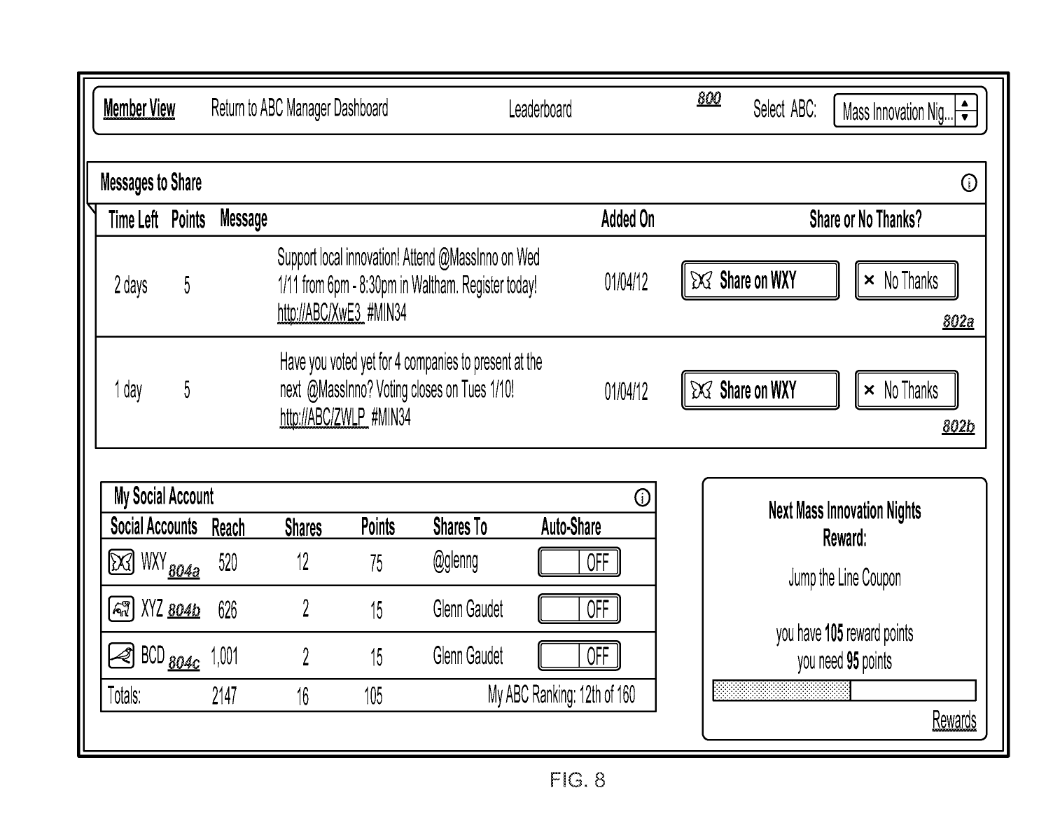

The system, in some implementations, may leverage the use of a web interface to allow an individual to share a message with associated social network members. Turning to FIG. 8, in some implementations, an interface 800 for distributing electronic messages includes a number of messages 802 presented for sharing. Each of the messages 802 may be shared via one or more social media accounts 804. In some implementations, the interface 800 may be downloaded or otherwise made available to a personal computing device such as a tablet computer, cellular phone, smart phone, personal data assistant (PDA), notebook computer, laptop computer, personal gaming device, or other computing device capable of providing an interface to a user networking system for sharing information posts. The interface 800, for example, may be presented within a browser interface, a mobile device application, or another application executing upon a computing device. In other implementations, a social medial network-specific version of the interface 800 may be accessed via one or more social media networks (e.g., via the social media network browser interface or mobile application).

In some implementations, a system for amplifying the distribution of information posts among members of one or more virtual communities may include a mechanism for an organization to use followers, fans, employees, or other interested individuals to distribute information on behalf of the organization. The individuals who join the system on behalf of the organization, for example, may have authorized the collection of personal and activity data associated with each respective individual. In some implementations, one or both of the personal and activity data may be collected on a specific community networking (e.g., social media) system. As a result, the system for amplifying the distribution of information posts may collect the data (e.g., from each individual community networking system), aggregate, analyze and report on a variety of data components. In this manner, the originator of the amplified content (e.g., the central organization, entity, or individual) may be provided with insights on which to make future decisions and improve the performance of this process. The system may use the data, in some implementations, in aggregate or at the individual level based on the desired reporting needs. As a result, the system can be quite useful in data collection and analytics whether or not the central organization or person actively invites members to act as a distribution mechanism.

The system, in some implementations, can provide rich analytics to both the central organization as well as the person that joins the construct. The system may track the messages not just sent via the system, but all messages that the members are creating, sharing and interacting with on the of the one or more community networking systems. The connection point between an individual and a particular community networking system, in some implementations, may be referred to as a user account. In some implementations, user accounts may be affiliated with or connected to the system for amplifying the distribution of information posts. For example, user account data may become part of the aggregate or individually reported on data. Examples of data collected and or reported on may include one or more of the following: Message; Message Behavior; Demographics; Message components including links (uniform resource locators (URLs)), video & audio; Account information; and Personal information.

In some implementations, the system may prevent amendment of a message such that members who choose to share the message may only share the message as it has been provided through the system. In other implementations, the system may provide the option of adding information to a message or otherwise amending a message. In some implementations, various degrees of amendment (e.g., adding information, altering information, etc.) may be allowed based upon individual member privileges. For example, an employee of an organization may be provided the opportunity to personalize a message prior to issuance, while a fan of the organization may only be capable of sharing a message in the state in which the message was provided to the member. As a result, for example, a central distributor of the message (e.g., owner, administrator, etc.) may have control over a full spectrum of options regarding message integrity, ranging from total message content lock down to allowing for a total message rewrite.

In some implementations, the data that is reported may or may not be the entirety of the data that is collected. The system, for example, may use some data at the account level and some data at the aggregate level. The system may have the flexibility to generate desired reports, for example, based on the data requirements of an individual or organizational member of the system for amplifying the distribution of information posts or on the data availability. For example, each social media network or other community networking system may include varying data collection mechanisms and/or varying access to collected data by the system for amplification and distribution of information posts.

Reporting of the data, in some implementations, may provide an organization or individual (e.g., the originator of a messaging campaign, a participant in a messaging campaign, the originator of an information post, a follower of a particular organization, etc.) an understanding as to how messages, individually and/or as a message group, are being accepted by the peer community of one or more members distributing each of the messages. Reports, for example, may illustrate the interactions of individuals with one or more messages. In another example, reports may be used to provide an analysis (e.g., topic, content, style, origination, etc.) of the messages that a community (e.g., members and peers within a particular social networking site, etc.) or a portion of a community (e.g., account holders who reside in a geographic region) is sharing within a particular community networking system.

Given the abundance of data that may be collected by the system, in some implementations, the reporting component may provide users (e.g., organizations or other originators of content for distribution through the system, etc.) of the system with a better understanding of the effectiveness of the messaging and communication strategy of each respective user. For example, information gleaned from reports provided by the system may be considered by a user in future communication strategy, allowing the user to make more effective decisions when distributing information through the system.

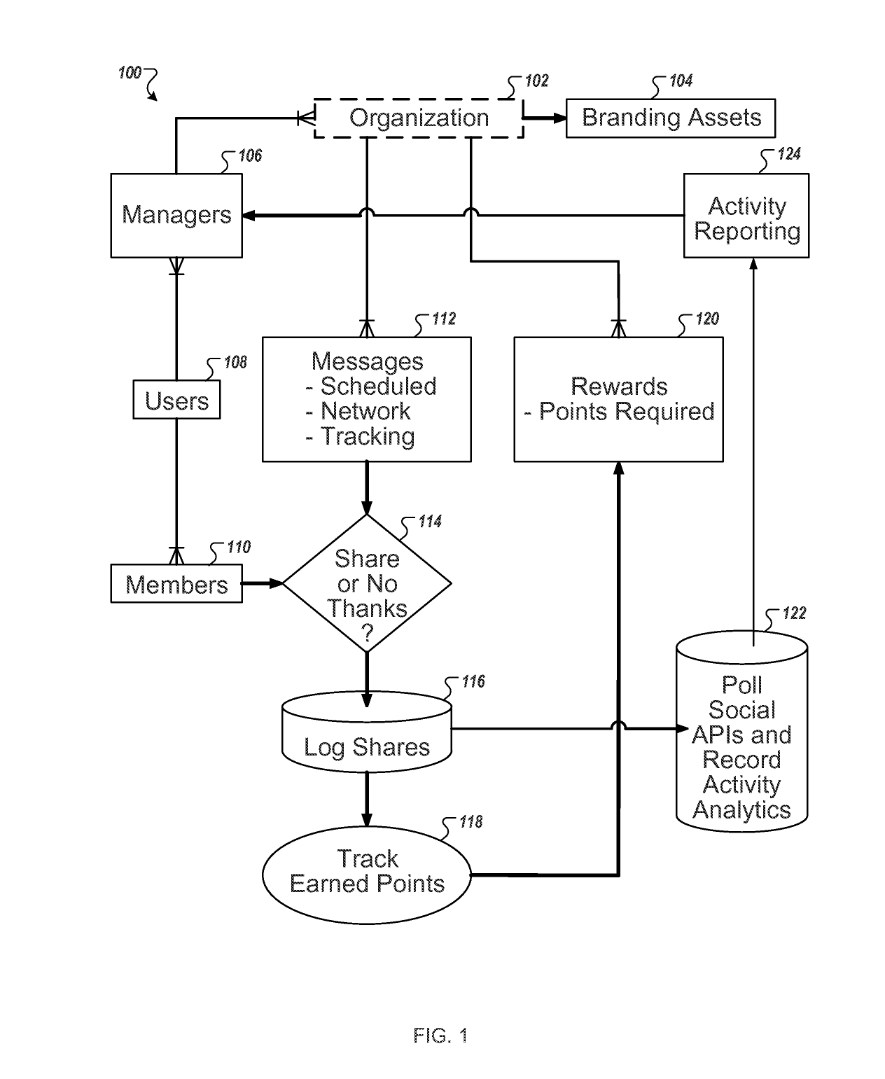

Referring now to the system in more detail, in FIG. 1 there is shown a system diagram 100 illustrating example data relationships involved for message distribution to the community. The element named Organization 102 may refer to a central body that may create and distribute one or more messages (e.g., information posts containing one or more of text, audio, graphic, and video data). The Organization 102, in some implementations, may include the ability to add a specific name (e.g., organization, product, service, trademark, etc.) and/or images (e.g., logo, product image, personal image, etc.) that, for example, are stored in the Brand Assets 104. Organizations 102, in some implementations, may be administered by the users as defined in a Managers element 106. A number of users 108, for example, may share messages on behalf of the Organization 102. These users, in some implementations, may be defined in the Members element 110 (e.g., containing account information regarding the users 108). In some implementations, the population of potential members 110 that become part of the Organization 102, administer the Organization 102, and/or share messages to respective social media networks and other community networking systems may be defined in the Users element 108. The Users element 108, for example, may be viewed as a superset of all potential people who may be included as part of the Organization 102. For example, each user 108 may become a member 110 of any number of organizations including the Organization 102, and thereby take part in multiple roles (e.g., of Members 110, Managers 106, administrators, etc.). Once a message has been generated and associated with the Organization 102, in some implementations, the message may be stored in the Message element 112. The Message element 112, for example, may contain specific information related to each of the one or more messages associated with each Organization 102. Information in the Message element 112 may include but is not limited to scheduling information, destination social network and other non-system system tracking information.

In some implementations, when a message 112 becomes associated with the Organization 102 and is available for sharing, members 110 of the Organization 102 may be notified of the new message 112 via a variety of message systems including, in some examples, email, mobile texting and social media messaging platforms. The Members 110, in some implementations, may be presented with a decision point, for example as shown in the Share or No Thanks element 114. The decision point 114, for example, may allow a member 110 the opportunity to decide whether to share the message(s) 112 via one or more social media accounts or to refuse (e.g., decline) to share the message(s) 112. If, for example, a Member 110 chooses to share one or more message(s) 112, the sharing activity may be tracked, in some implementations, in the Log Shares element 116 and the message(s) 112 may be distributed to the one or more user accounts (e.g., accounts to social media networks or other community networking systems) associated with the member 110. Distribution to each community networking system, in some implementations, may be implemented via an available application programming interface (API) provided by a particular networking system.

This sharing event, in some implementations, may trigger a Track Earned Points element 118. The Track Earned Points Element 118, for example, may provide an updated count of points associated with the sharing of each message 112. These message points, in some implementations, may be earned by individual members 110 through sharing messages 112 or other information posts through the system 100. The message points, for example, may be tracked, in some examples, to provide a gamification component to the system 100 and/or the ability for the Organization 102 to have assigned reward levels. For example, message points earned via sharing messages 112 on behalf of the Organization 102 may equate to one or more items the Organization 102 may use as the rewards for participating in the distribution and amplification of information on behalf of the Organization 102. Reward items, in some examples, may include gift certificates, t-shirts, and recognition (e.g., membership levels, early access to product or service releases, etc.). The reward level information, in some implementations, may be tracked by the Rewards Points Required element 120. The Rewards Points Required Element 120, in some implementations, may maintain the status of each member's ability to claim such reward.

Once a message 112 has been shared via one or more social networks or other community networking systems, a Poll Social APIs and Record Activity Analytics element 122, in some implementations, may gather data, for example via the API of each respective social media network or community networking system. Information from the Poll Social APIs and Record Activity Analytics element 122, in some implementations, may be collected and delivered to an Activity Reporting element 124, for example—for parsing, analysis and display of information in part, aggregate or calculated based on the needs of the report.

Still referring to the system 100 of FIG. 1, the overall result of the information relationships and flow within the described system 100 may include providing a system that enables multiple people controlling one or more social media or other community networking accounts to receive notification of centrally distributed social media messages that may then be shared based on the decision of each individual Member 110.

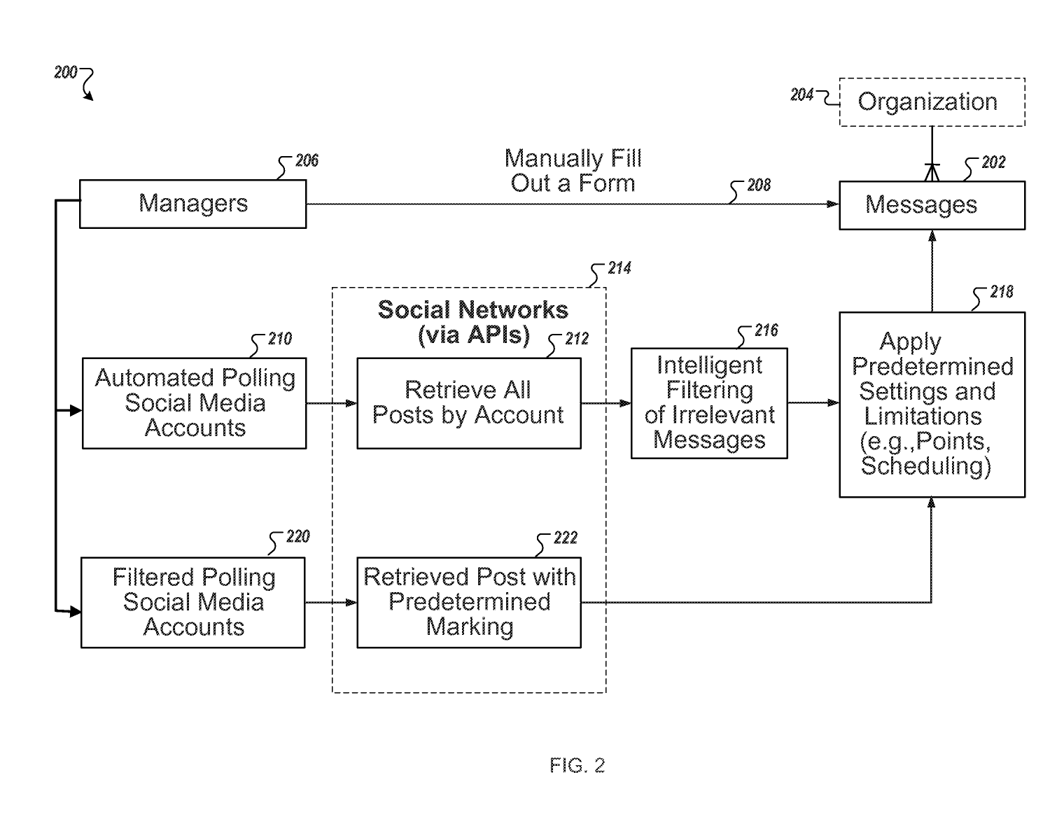

Messages 112 may be added to the system 100, in some implementations, via a variety of mechanisms, including but not limited to the techniques shown in FIG. 2. FIG. 2 is a flow diagram of example distribution paths for distributing messages in a system for amplification and distribution of information posts, such as the system 100 described in relation to FIG. 1. Turning to FIG. 2, messages 202 are brought into the system and stored, for example, in a central message store associated with an Organization 204. As illustrated, the delivery mechanisms may include a variety of methods in which messages are delivered to the Message element 202. In a first example, an operator of a Manager element 206, for example, the user account established as the administrator of the Organization 204, may manually fill out 208 an electronic form containing a specific message and desired characteristics for the message. This information, for example, may be packaged together and delivered to the Message element 202. In other examples, the administrator functioning within the Manager element 206 may upload a document, such as a spreadsheet, containing message information for generating a number of messages.

In some implementations, the role of an operator of the Manager element 206 includes specifying one or more networking community accounts, blog feeds, Rich Site Summary (RSS) feeds, or other information feeds to monitor for accessing new content. In a second example of a delivery method, the Automated Polling Social Media Accounts element 210 may gather social media messages from designated social media accounts on designated social media networks, and deliver the gathered messages to the Message element 202. In addition to social media accounts, other networking community accounts, blogs, RSS feeds, or social media management system accounts may be designated for gathering new content.

In some implementations, the Automated Polling Social Media Accounts element 210 may apply one or more filters to the messages prior to delivering the messages to the Message element 202, thus selecting a subset of initially gathered messages. The gathered messages, in some implementations, may be collected by a Retrieve All Posts by Account element 212, which gathers the messages of the designated accounts on the various social media networks 214. The messages may be filtered, in some implementations, by the Intelligent Filtering of Irrelevant Messages element 216. Filters may be applied, for example, to discard public replies, retweets, reposts, and other communications other than top level original content presented via the designated account (e.g., social media account, etc.). The filtered messages, in some implementations, may then be made available for applying pre-set desired characteristics and/or tracking requirements as illustrated in the Apply Predetermined Settings and Limitations (e.g., Points, Scheduling) element 218. In some implementations, the characteristics in all methods may include but are not limited to scheduling, campaign information, tracking codes and information.

In a third example method for message delivery, a Filtered Polling Social Media Accounts element 220 may provide a mechanism for populating messages into an Organization's Message store 202, in some implementations, by polling the messages of designated social media accounts (e.g., social media accounts of retailers, brands, licensed characters, board members, events, customer service affiliates, resellers, and other sub-organizations or esteemed members of the organization) and applying a filter based on a specific mark contained within one or more messages. For example, a user may apply a mark, such as an icon, text phrase, metadata tag, HyperText Markup Language (HTML) tag, or other distribution flag, to a message posted to a first social media account, alerting the system 100 to the availability of the particular message for distribution to further community networking systems. A Retrieved Post with Predetermined Marking element 222, for example, shows a filtering layer that may be applied to the messages based on a pre-determined mark that may be contained in the message, such as a hashtag, emblem, identifying code, pre-selected string of text or symbols provided by the user, or other unique identifier. Similar to the Automated Polling Social Media Accounts element 210, the Retrieved Post with Predetermined Marking element 222, as illustrated, provides an example method for filtering and delivering one or more messages to the Apply Predetermined Settings and Limitations (e.g., Points, Scheduling) element 218.

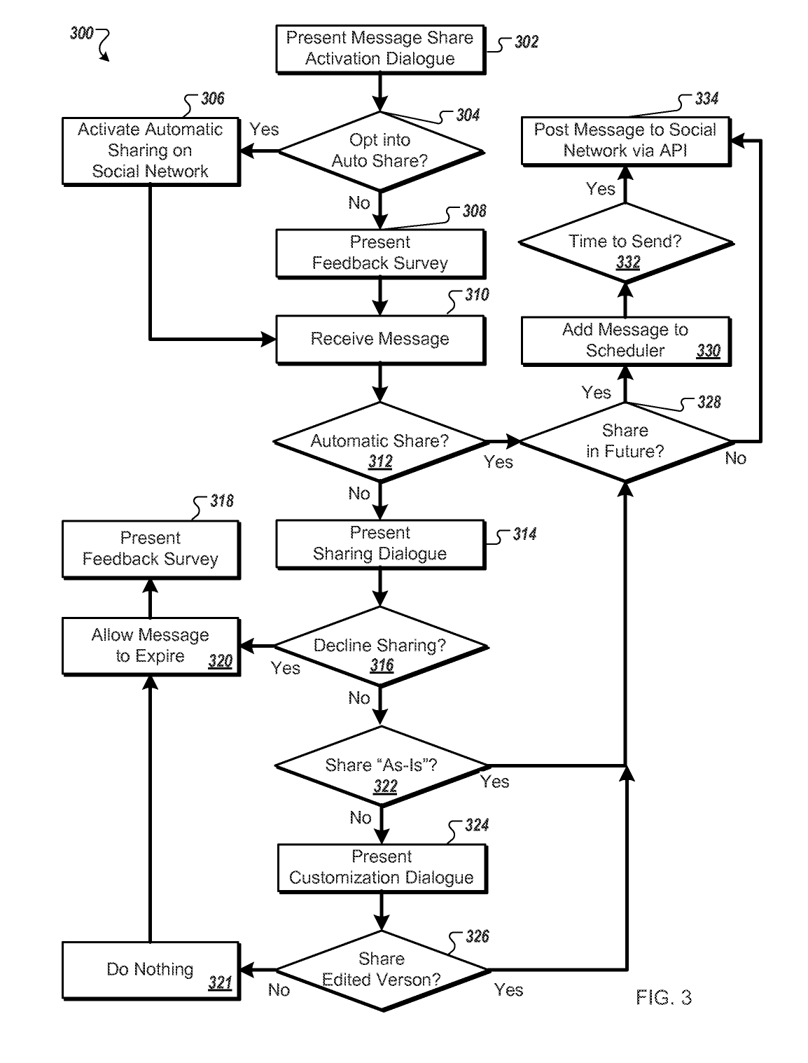

Once messages 202 have been posted to the community associated with the Organization 204, in some implementations, the members may be provided with a decision process that allows the messages 202 to be shared to the respective user accounts associated with each member of the community. Turning to FIG. 3, a flow chart illustrates an example method 300 for distributing messages via community networking based upon a number message sharing options provided to members of the community. Messages, for example, may be placed into the repository for the organization. This repository, for example, is shown as the Message element 202 of FIG. 2. The system, in some implementations, may follow a series of one or more tests, for example to determine whether a particular message is eligible for sharing and when a message may be scheduled for sharing.

In some implementations, the method 300 begins with presenting a message sharing activation dialogue (302). For example, a user may be offered the opportunity to sign up as a member of a community for sharing messages on behalf of an entity (e.g., individual, organization, etc.). The user, in some implementations, provides configuration parameters for membership such as, in some examples, one or more community networking accounts (e.g. username, personal URL, hashtag, etc. for accessing a social media account of the user), email address, name, and association with the entity (e.g., employee number, affiliation, etc.).

In some implementations, the user is presented with the option to activate automatic sharing of messages (304). In some implementations, the system may include a member-defined variable that, when set, allows for automatic sharing of all messages that are targeted for a particular social media network or other community networking system.

In some implementations, the member activates automatic sharing (306). In some implementations, automatic sharing is set on a per-account basis (e.g., per social network or other community networking affiliation). In some implementations, the automatic sharing option is set across all accounts.

If, instead, the member declines automatic sharing, in some implementations, a feedback survey is presented (308). The feedback survey, for example, may be used by the entity to determine what reservations members may have in activating automatic sharing.

In some implementations, a message is received (310). The message, for example, may enter the system via one of the routes described in relation to FIG. 2.

In some implementations, it is determined whether automatic sharing is activated for the message (312). The Automatic Share flag may be preset by a member. Based on the setting of this flag, the system may define whether a message may be automatically posted to one or more additional user accounts associated with the particular member. If the Automatic Share flag is set in the affirmative, for example the message may be shared without additional approval or interaction with the member.

If the Automatic Share flag is not set to the affirmative (312), in some implementations, the system may notify the respective member that one or more messages are in the repository, for example as discussed in relation to FIG. 2. Still referring to the method 300, in some implementations, the member is presented with a sharing dialogue (314). For example, the member may then be given an opportunity to share each individual message or to decline sharing. The member may accept or decline, in some examples, via email, text message, a mobile application interface, a browser application interface, or an offer presented within a particular social networking account (e.g., within a browser or mobile application interface).

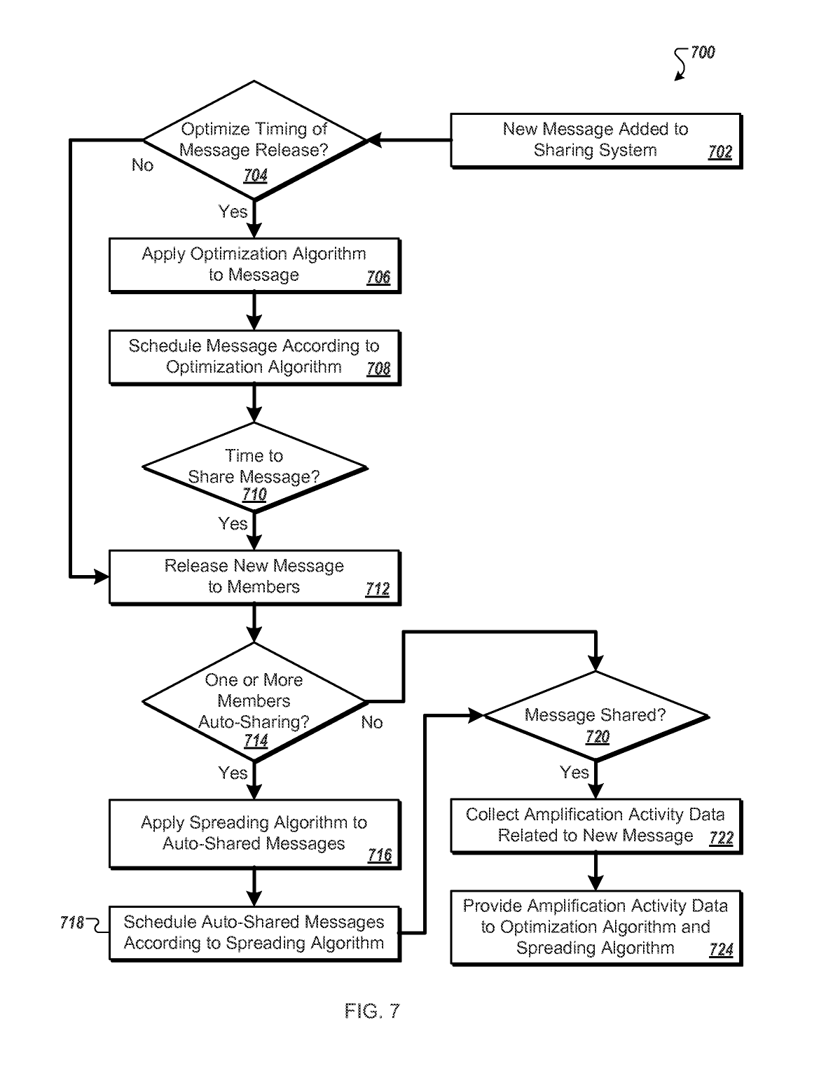

In some implementations, the member declines sharing (316). If the refuse option is in the affirmative, in some implementations, the member is presented with a mechanism that allows the member to provide feedback to the entity (318). The member, for example, may be presented with a feedback survey. In some implementations, upon declining to share, the message is allowed to expire (320). A message may expire, for example, based upon a number of active messages (e.g., up to ten messages actively being shared by members at a time, upon an expiration date or time of the message (e.g., message expires after 24 hours, message set to expire at end of business on Thursday, etc.). The option for approving a message for sharing, for example, may expire such that a user is no longer permitted to approve sharing of the message beyond the expiration of the message. As illustrated in a report 1100 of FIG. 11, for example, a messages active trace illustrates a number of active messages at given points throughout a time period 1104, while a new messages starting trace illustrates a number of messages being activated (e.g., provided for sharing) at a given point in time. In some implementations, messages may be queued for release on a particular date or at a particular time, as will be described in further detail in relation to FIG. 7.

If the member, instead, chooses to share the message (316), in some implementations, the member may then be presented with the decision to share the message in a current state (322). If the member declines sharing the message “as-is” (322), in some implementations, the member is provided the opportunity to customize the message (324). For example, the member may be presented with a customization dialogue configure to allow the user to modify or amend the message. The system may provide a mechanism for the member to share the message with one or more member edits incorporated. In some implementations, the customization option depends upon settings applied by the organization on a global or per-message basis. For example, the organization may determine that a user is provided the opportunity to amend certain messages, but other messages are configured to be shared as-is. In some implementations, a member's ability to customize messages is dependent in part upon the permission settings or assigned role of the member. For example, in some implementations, employees, affiliates, or other trusted members may be provided the opportunity to customize messages, while members with more restrictive permission settings (e.g., fans, customers, clients, etc.) may only have the option to send a message as-is.

In some implementations, if a member fails to share as-is (322) and also fails to share a customized version (326), no action is taken within a set time period for acting upon the offer to share the message (321). In this circumstance, the message fails to be shared and expires (320). For example, should a user close out or suspend activity while customizing a message and fail to return to the message within a certain time period, then the message may expire. In some implementations, upon expiration, the member is presented with a feedback survey (318) to determine why the member failed to act upon the offer within the set time period.

In some implementations, if a member actively declines to share an edited version (326), the sharing dialogue (e.g., “as-is”) is presented to the member (314).

Whether a message is sent automatically (312), with user acceptance, as-is (322), or with application of a customized amendment (326), in some implementations, a message may be scheduled for sharing at a future time (328). An intelligent scheduling system, for example, may determine, based upon analysis of member activity and engagement with (consumption of) messages by others (e.g., followers, friends, colleagues, etc.) reviewing messages presented on behalf of members, time periods (e.g., days of the week, time of day, etc.) where messages benefit from highest consumption (e.g., the largest number of engagements such as, in some examples, the most re-posts, links, likes, comments, retweets, click-throughs, etc.). A scheduling algorithm, for example, may be used to schedule sharing of the message at a future time such that the message is more likely to reach a large audience. For example, should a member access the system at 3 am and has opted to share a message intelligently, then the message may be delayed until an audience is awake and likely to view the message (e.g., 9:00 a.m., etc.). The scheduling algorithm, in another example, may determine that messages are more likely to receive traffic on Monday mornings than Sunday evenings and delay sharing of a message overnight.

In some implementations, (e.g., upon activation of a timing mechanism set by the scheduling algorithm (322) or immediately) the message is shared (334). For example, the message may be shared via one or more designated user accounts associated with one or more social media networks or other community networking systems. For example, the system may communicate directly with a respective API of a targeted social media network in order to accomplish this message posting.

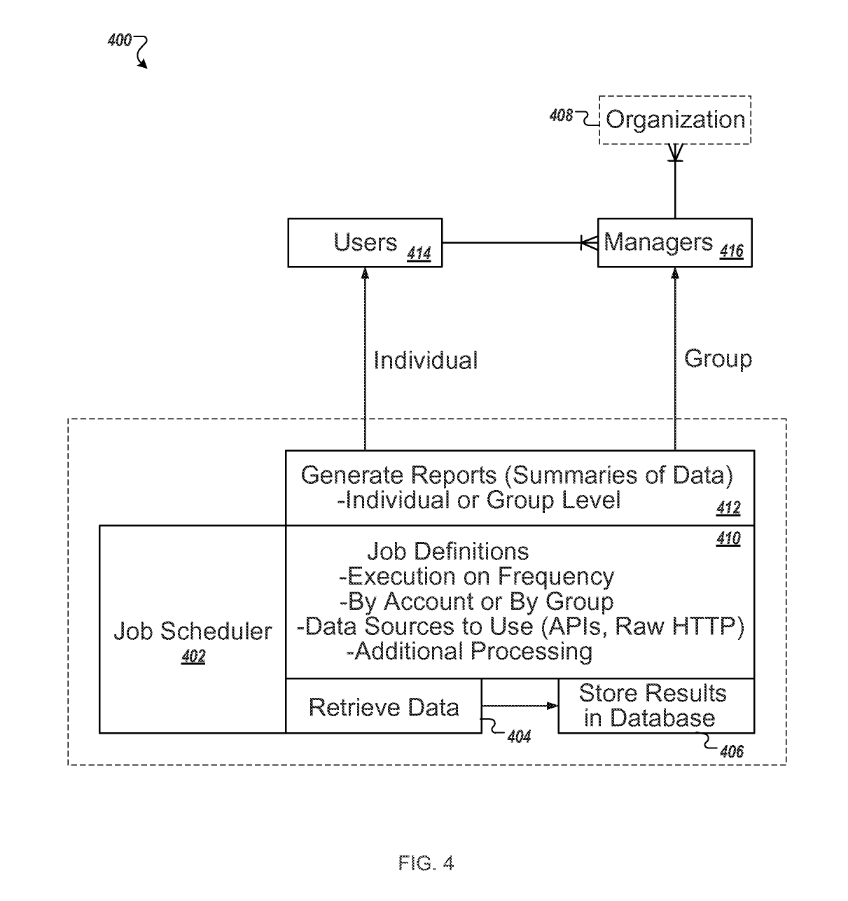

Whether message distribution activities are simultaneously taking place or not, in some implementations, the system may be actively collecting data regarding a number of designated user accounts on one or more social media networks or other community networking systems. For example, the system may collect data directly from each designated social media network. An example data collection process is described in relation to FIG. 4, which includes a block diagram illustrating example data relationships involved for community demographics and social network interactions in a system 400 for sharing messages via community networking. The system 400, in some implementations, may continuously request information from the designated social media networks, for example as shown in the Job Scheduler element 402. The Job Scheduler element 402, in some implementations, includes an automated mechanism which manages the data collection. The data collection, for example as shown in the Retrieve Data element 404, may include storing a portion of the data to a data store, for example as shown in the Store Results in Database element 406. The Job Scheduler frequency and data requests, in some implementations may be based in part on the needs of a particular Organization 408 or by requirements defined by the system. This is shown, for example, in the Job Definitions element 410. The frequency of data requests, in some implementations, are based in part upon availability of new information as presented by each respective social media network. Data requests, for example, can include requests made through application programming interfaces (APIs) for information regarding engagement activity such as comments, re-posts, retweets, and other data regarding the consumption of messages.

Based on the data collected, in some implementations, the system analyzes a portion of the data and reports on the various data collected. In some examples, data may be analyzed and provided in reports in siloed or aggregated data sets. The analysis and reporting method, for example, may be shown in the Generate Reports element 412. Reports may generated and exposed, in some implementations, based in part on the target viewer of such data. For example, a target viewer may be at the organization level or an individual member level. Reports generated for the individual level, in some implementations, may be provided to the member as shown by the Users element 414. Reports that are generated for the organization level, in some implementations, may be passed on to the manager or administrator of the organization, for example as shown in the Managers element 416. In some implementations, whether a report is designated for an individual member 414 or for the organization 408, all of the reports may be contained under the specific organization container, for example as shown in the Organization element 408.

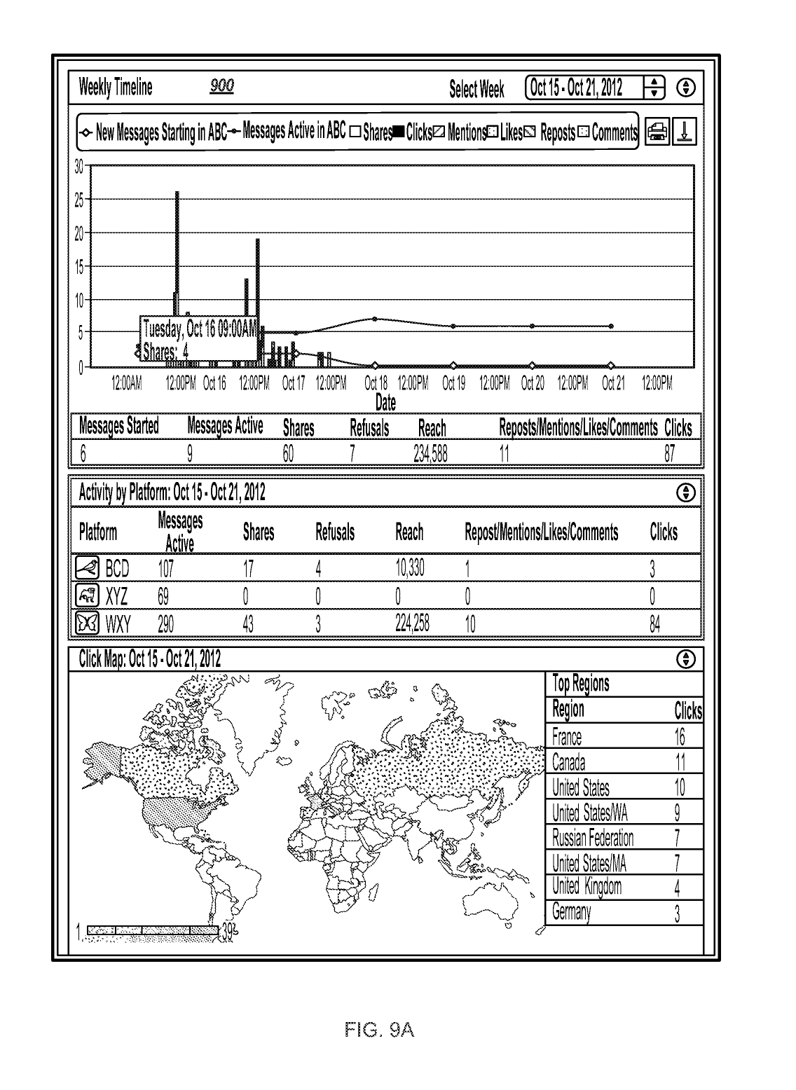

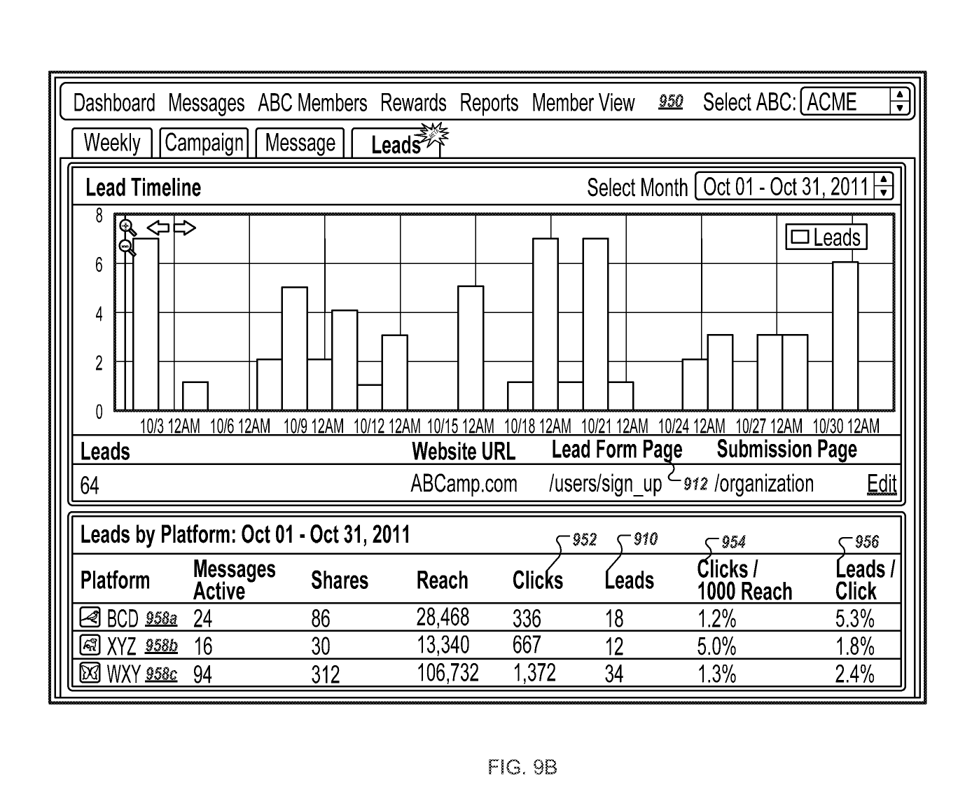

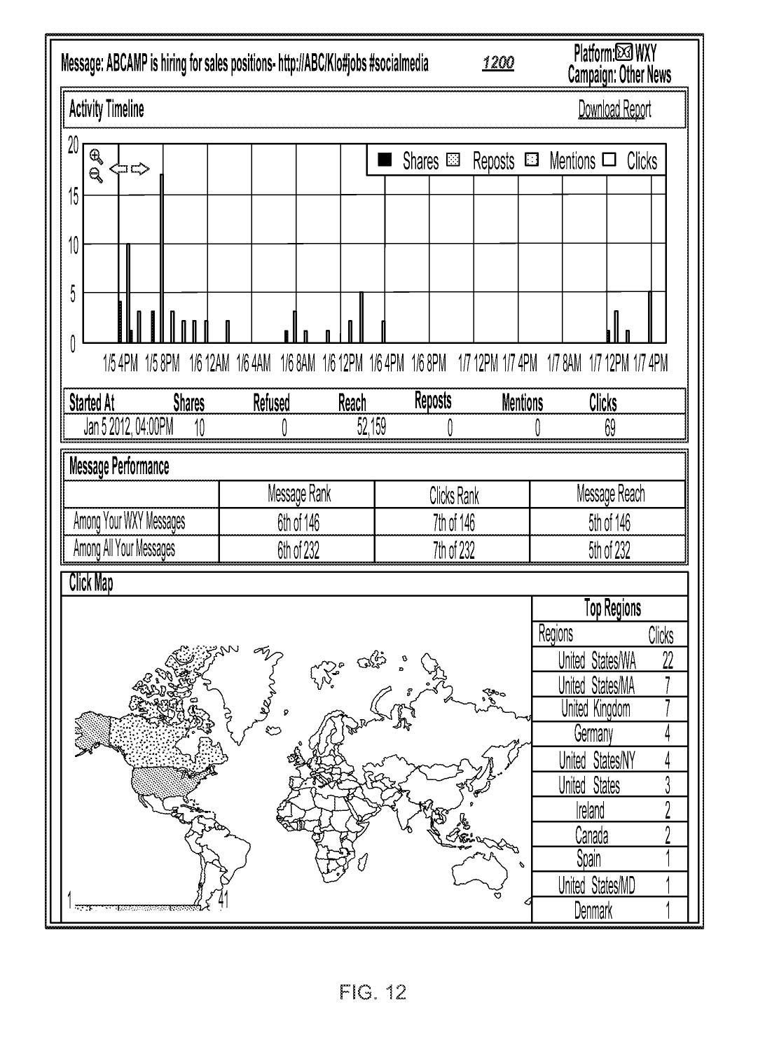

Example reports are illustrated in FIGS. 9 through 14. Reporting of the data, in some implementations, may provide an organization or individual (e.g., the originator of a messaging campaign, a participant in a messaging campaign, the originator of an information post, a follower of a particular organization, etc.) an understanding as to how messages, individually and/or as a message group, are being accepted by the peer community of one or more members distributing each of the messages. Reports, for example, may illustrate the interactions of individuals with one or more messages, such as a report 1200 illustrated in FIG. 12. In another example, reports may be used to provide an analysis (e.g., topic, content, style, origination, etc.) of the messages that a community (e.g., members and peers within a particular social networking site, etc.) or a portion of a community (e.g., account holders who reside in a geographic region) is sharing within a particular community networking system.

In some implementations, organizations or entities are provided access to social activity reports illustrating an amount of social activity generated through use of the community networking system. Data included in social activity reports, for example, can include social shares (e.g., message posts by members), a geographic location analysis of activity, and second-level engagements generated from message posts (e.g., retweets, mentions, likes, comments, click-throughs, re-posts, shares, etc.). Social activity reports, in some examples, may be generated based upon various time frames (e.g., day, week, etc.), groupings of messages (e.g., messaging campaigns, etc.), networking community activity regarding a particular networking community (e.g., Facebook™, Twitter™, LinkedIn™, etc.), or a subset of activity within any of the aforementioned segments.

Turning to FIG. 9A, for example, a social activity report 900 illustrates messages distributed on behalf of a particular organization or entity. In a particular example, turning to FIG. 9B, the system may provide a uniform resource locator (URL), which tracks click-throughs, that may be inserted into one or more messages placed in the system. In a particular example, in reviewing a report 950, report data may include information on the number of click-throughs 952 that are achieved with that message.

In some implementations, the system may provide one or more reports that compare and contrast the interactions of individuals with one or more messages across two or more community networking systems. For example, turning to FIG. 9B, a click-throughs per reach 954 and a leads per click 956 can be compared between three different community networking systems 958.

In some implementations, social activity reports may be extended with additional data derived from third party services that track marketing and sales activity. These services may include, for example, web analytics tools, marketing automation systems, or customer-relationship management (CRM) systems. Data may be aggregated between the third party system and the community networking system via URL parameters and APIs. As illustrated in FIG. 9B, for example, a leads column 910 may demonstrate a link between the activities generated via the community networking system and eventual sign up by new users (e.g., via a lead form page 912) of the organization. Through the introduction of the third party data, in some implementations, the organization can more precisely and accurately determine the value of any given unit of activity attributed to message amplification using the community networking system.

In some implementations, organizations or entities are provided access to member consumption reports illustrating member participation in sharing messages via the community networking system. The member consumption reports, for example, may illustrate how different attributes (e.g., number of messages presented for sharing, timing of the distribution of messages for sharing, etc.) effect the approval rate of the messages (e.g., messages approved for sharing by members of the organization). Attributes included within a member consumption report, in some examples, may include the number of members registered for message sharing on behalf of the organization, frequency at which new messages are posted to networking communities, and a spread of the messages (e.g., an amount of time elapsed between each new message posted). In reviewing member consumption reports, the organization can determine how changes in various attributes (e.g., number of active messages, spread between messages, etc.) affect the participation of members. In optimizing these attributes over time, the organization may increase participation, thus generating more activity. In some implementations, rather than reviewing and adjusting by hand, an optimization algorithm may be employed by the community networking system to automatically optimize the posting time of messages based upon member consumption data.

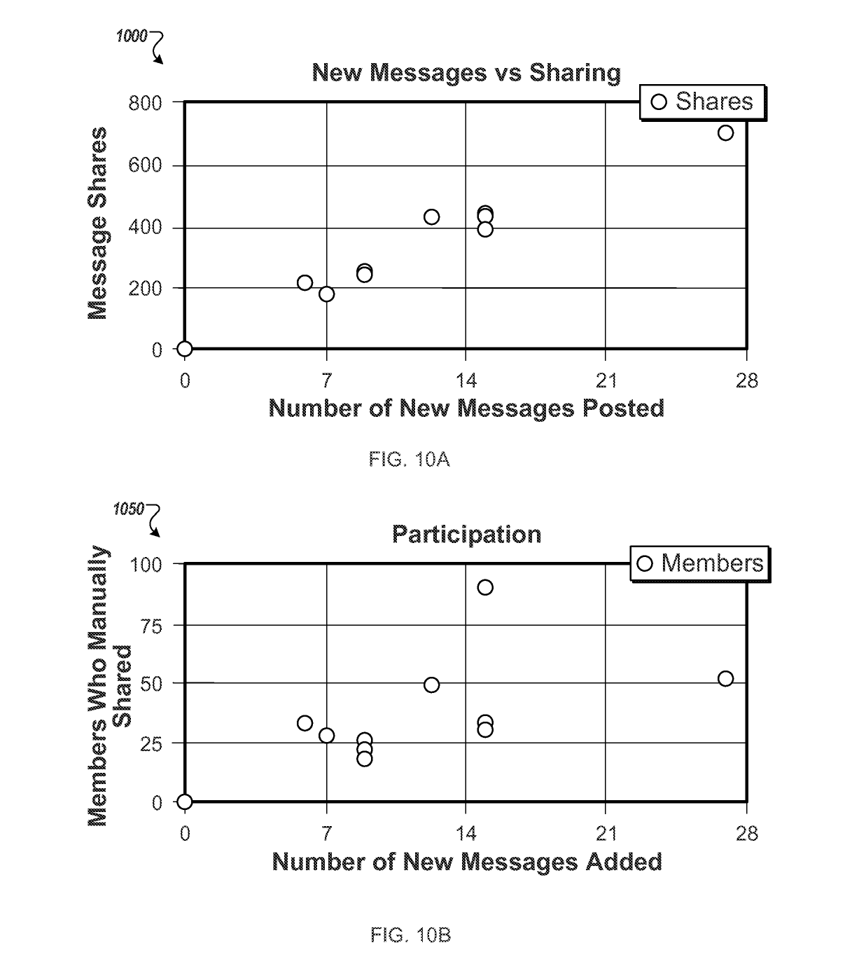

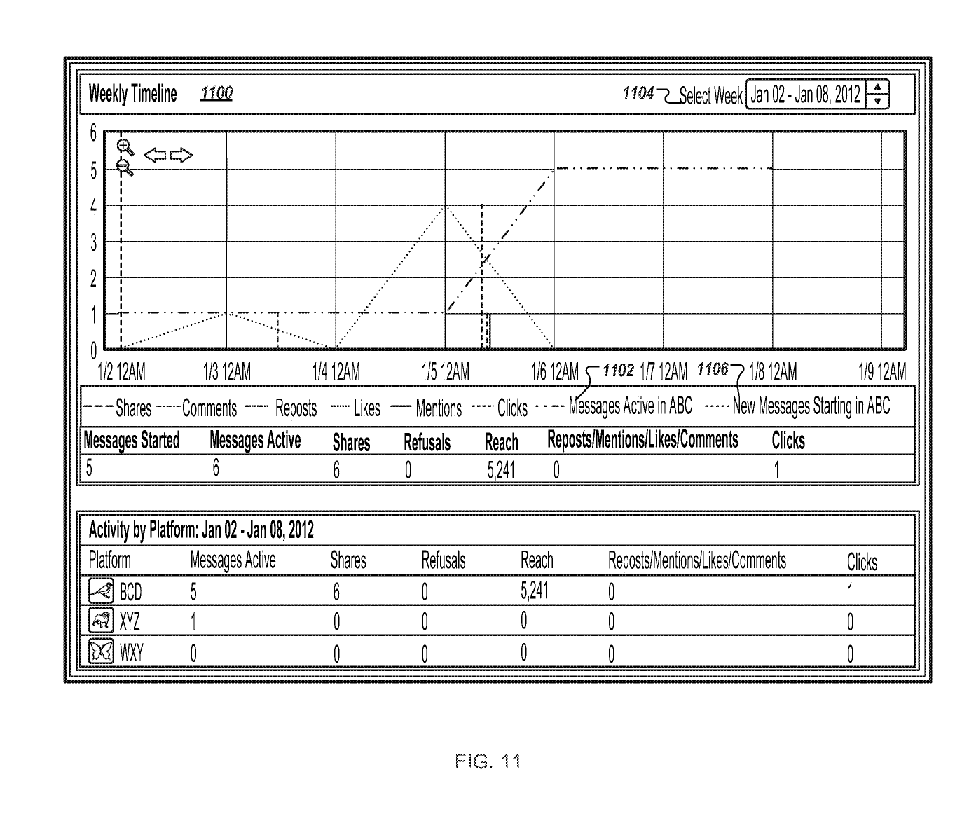

FIGS. 10A and 10B illustrate example consumption data reports 1000 and 1050 used demonstrate member participation metrics. Turning to FIG. 10A, the report 1000 illustrates a trade-off between a number of new messages available for sharing and an actual number of messages shared. The report 1000, for example, may demonstrate a saturation point at which members are disinclined to share additional messages. Turning to FIG. 10B, the report 1050 illustrates a trade-off between a number of new messages available for sharing and a percentage (or actual number) of members who shared one or more of the new messages. The report 1050, for example, may demonstrate a correlation between a number of available messages for manual approval and the number of members participating.

The system may, in some implementations, analyze multiple messages that were not distributed by the members of the organization (e.g., not approved for manual sharing), for example to provide an analysis of the content of messages. In this manner, further to the example, the system may determine one or more trends in the content of interest to the members of the organization.

In some implementations, organizations or entities are provided access to member behavior reports illustrating participation and retention behavior of the members in using the community networking system. In viewing a member behavior report, for example, the organization can identify a number or percentage of members performing certain actions, and how the number or percentage changes over time. In another example, a member behavior report may illustrate whether members are performing actions once, for a “honeymoon” period (e.g., brief period time after registration as a member, such as three days, one week, one month, etc.), or on an ongoing basis. Additionally, a member behavior report may be used to identify a lag between performance, by a member, of an action (e.g., approval of a message) and issuance of the request to the member to perform that action (e.g., option to share message provided). Based upon review of the member behavior reports, for example, the organization can identify behaviors of the members and implement strategies to alter the behavior to better achieve goals of the organization (e.g., improve retention, increase participation, etc.).

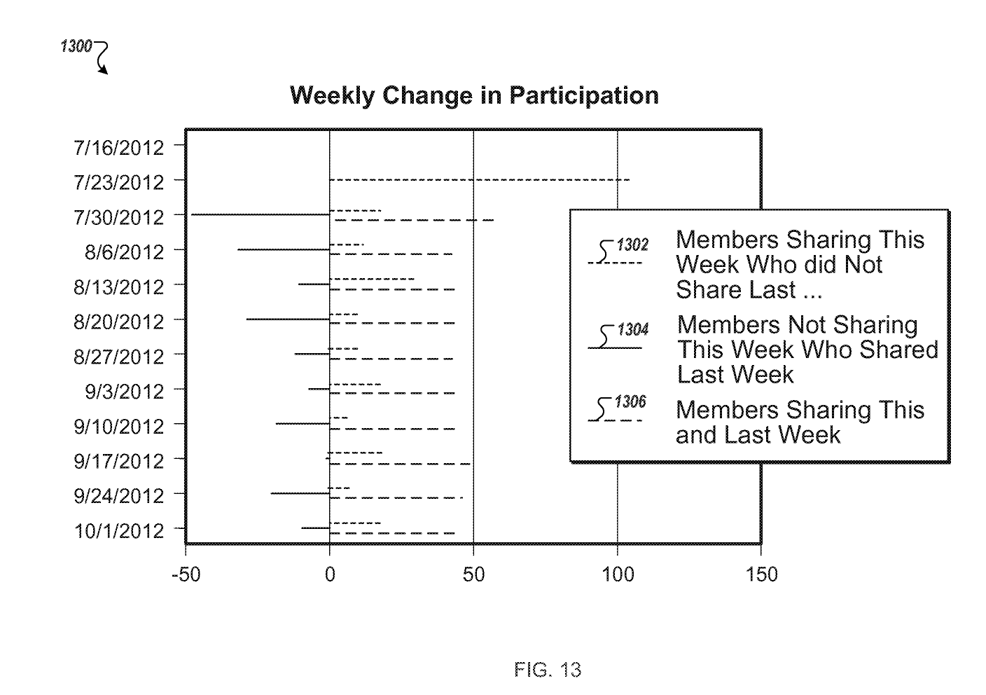

Turning to FIG. 13, a member behavior report 1300 illustrates a weekly change in participation over a period of time from July 16 to October 1. The report 1300 identifies a number of members sharing on a current week who did not share on the prior week 1302, a number of members not sharing on a current week who did share on the prior week 1304, and a number of members sharing in two consecutive weeks 1306.

In some implementations, organizations or entities are provided access to social network behavior reports illustrating patterns in activity that occurs on third party social networks. In some implementations, the social network behavior reports encompass activities outside the scope of the community networking system (e.g., information exchanges and other behaviors of members of the organization as derived from data provided by a particular third party network). The social network behavior reports, for example, can demonstrate time periods of increased activity on a per-social network (or other type of community network) basis. For example, in reviewing a social network behavior report, an organization can analyze general behavior patterns of members of a given social network.

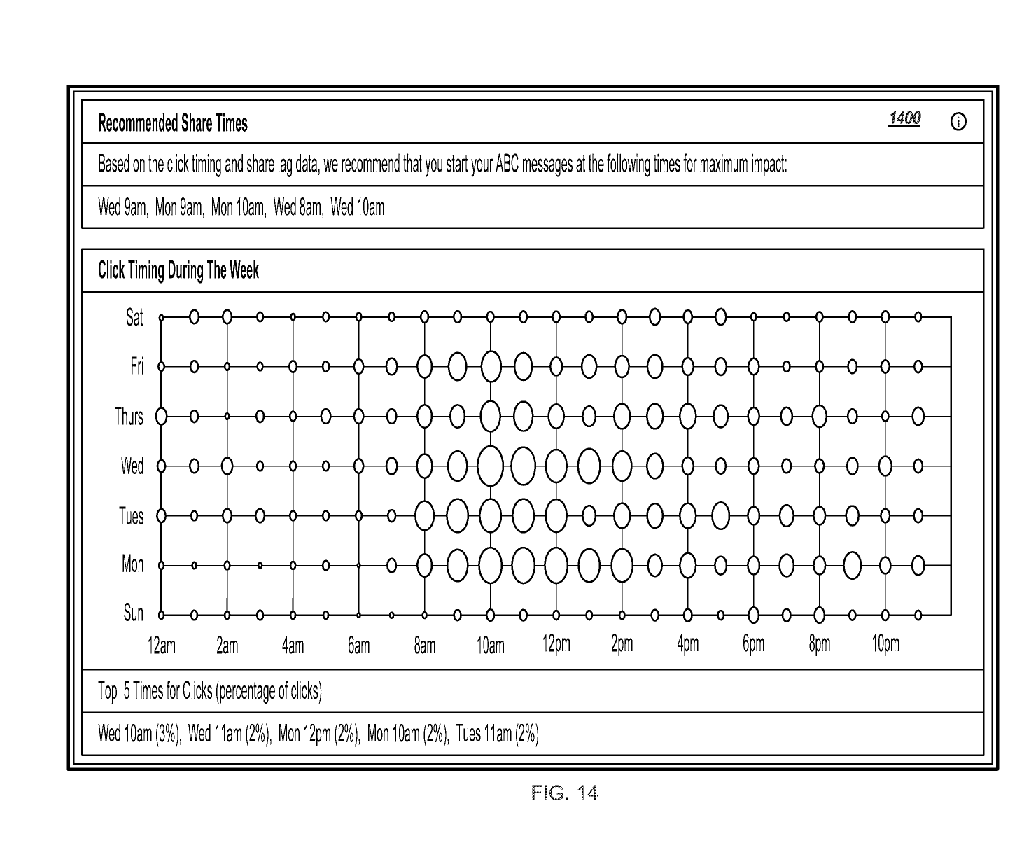

Turning to FIG. 14, a social network behavior report 1400 illustrates an impact diagram identifying relative click-through traffic based upon time of day and day of the week for a particular social network. In viewing the report 1400, for example, it may be determined that traffic patterns indicate that a message may be viewed by a larger audience if posted on a weekday morning rather than on a weekend. In reviewing the report 1400, for example, the organization can time distribution of messages to have an increased impact.

Turning to FIG. 7, flow chart of an example method 700 for intelligent scheduling of message release and sharing is provided. The method 700, for example, may be performed by a system for community networking of messages as described in relation to FIGS. 1, 2, and 4. Intelligent scheduling, for example, can be achieved through statistical analysis of data such as the data described in relation to the reports in FIGS. 9A through 14.

In some implementations, the method 700 begins with adding a new message to the sharing system (702). The message, for example, may be introduced using one of the paths described in relation to FIG. 2.

In some implementations, if the timing of release of the message is to be optimized (704), an optimization algorithm is applied to the message (706). The message, for example, may be released for sharing during a day of the week and/or a time of the day predicted to have a history of high traffic (e.g., reviews, click-throughs, etc.). The report 1100, as illustrated in FIG. 11, for example, illustrates variations on sharing, re-posting, and other indications of consumption of a message (e.g., likes, mentions, clicks, etc.) within a weekly timeline. In another example, the report 1400 of FIG. 14 demonstrates activity patterns within a particular community network environment based upon days of the week and times of day. Using the type of statistical information illustrated within the report 1100 of FIG. 11 and the report 1400 of FIG. 14, for example, an optimization algorithm may be developed to schedule the sharing of messages at times that historically exhibit high traffic.

In some implementations, the message is scheduled according to the optimization algorithm (708). For example, the message may be queued and provided a timer for release at a particular time of day or on a particular day of the week. In some implementations, the organization may additionally specify timing preferences. For example, an organization may queue messages in advance for a marketing campaign (e.g., Black Friday after Thanksgiving). The organization may specify a time window, based upon the marketing campaign, during which the message can be released and then the optimization algorithm may specify the distribution time during the time window.

In some implementations, upon time for release of the message (710), the new message is released to members (712). In some implementations, the option to share the message is presented to a member via one or more alert mechanisms such as, in some examples, email, text message, offer within a browser window of the system for community sharing of messages, a mobile application of the system for community sharing of messages, or via a particular social network API.

In some implementations, if one or more of the members have enabled auto-sharing of messages (714), a spreading algorithm is applied to the auto-shared messages (716). In some examples, scheduling of messages may be determined based in part upon a particular social network (e.g., Facebook traffic differs from Linked-In traffic, etc.), one or more demographics of the member and/or the member's followers (e.g., geographic region of the member determines a time zone, age group of the member determines a consumption pattern, etc.), and a periodic delayed release (e.g., over one or more periods of time determined to have higher traffic) such that the message does not appear on the social accounts of every member at the same time. In a particular example, if there are ten members who have enabled automatic sharing and the message is scheduled for release at 9 am, the system will automatically spread out the distribution of those messages over a time window. The distribution times may be determined based on an intelligent scheduling algorithm or a fixed time period.

In some implementations, the auto-shared messages are scheduled according to the spreading algorithm (718). For example, the message may be queued to release on particular accounts at particular times.

After the time scheduled for message sharing (720), in some implementations, amplification activity data related to the message is collected (722). Data may be collected, for example, as described in relation to FIG. 4.

In some implementations, amplification activity data is provided to the optimization algorithm and the spreading algorithm (724). The optimization algorithm and the spreading algorithm, for example, may be fine-tuned based upon incoming statistics such that the algorithms improve over time to ensure that messages receive optimized attention.

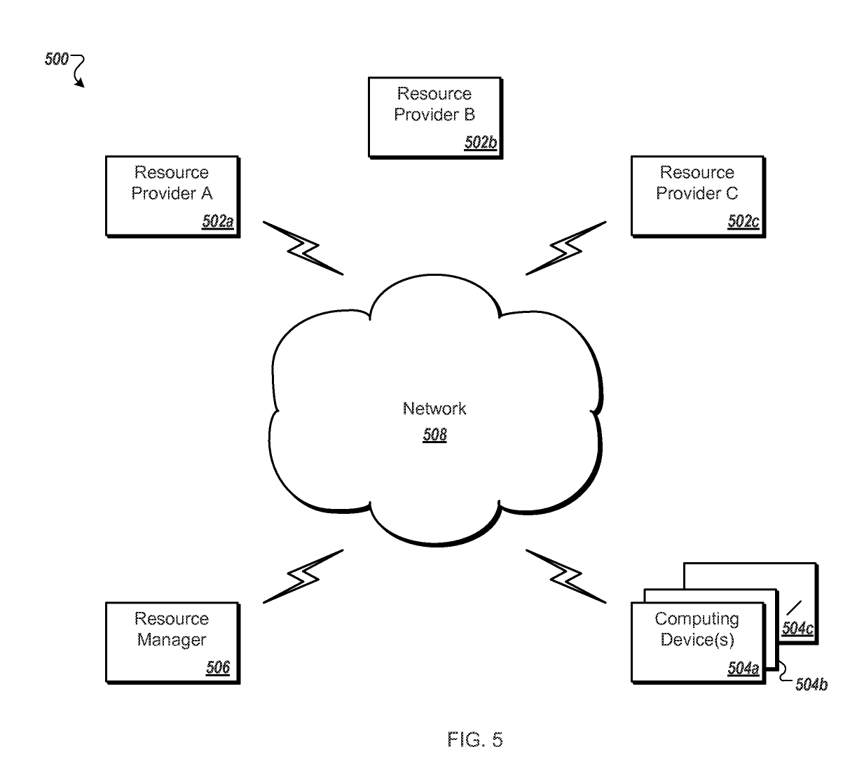

As shown in FIG. 5, an implementation of an exemplary cloud computing environment 500 for distribution and amplification of information posts is shown and described. In brief overview, the cloud computing environment 500 may include one or more resource providers 502a, 502b, 502c (collectively, 502). Each resource provider 502 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 502 may be connected to any other resource provider 502 in the cloud computing environment 500. In some implementations, the resource providers 502 may be connected over a computer network 508. Each resource provider 502 may be connected to one or more computing device 504a, 504b, 504c (collectively, 504), over the computer network 508.

The cloud computing environment 500 may include a resource manager 506. The resource manager 506 may be connected to the resource providers 502 and the computing devices 504 over the computer network 508. In some implementations, the resource manager 506 may facilitate the provision of computing resources by one or more resource providers 502 to one or more computing devices 504. The resource manager 506 may receive a request for a computing resource from a particular computing device 504. The resource manager 506 may identify one or more resource providers 502 capable of providing the computing resource requested by the computing device 504. The resource manager 506 may select a resource provider 502 to provide the computing resource. The resource manager 506 may facilitate a connection between the resource provider 502 and a particular computing device 504. In some implementations, the resource manager 506 may establish a connection between a particular resource provider 502 and a particular computing device 504. In some implementations, the resource manager 506 may redirect a particular computing device 504 to a particular resource provider 502 with the requested computing resource.

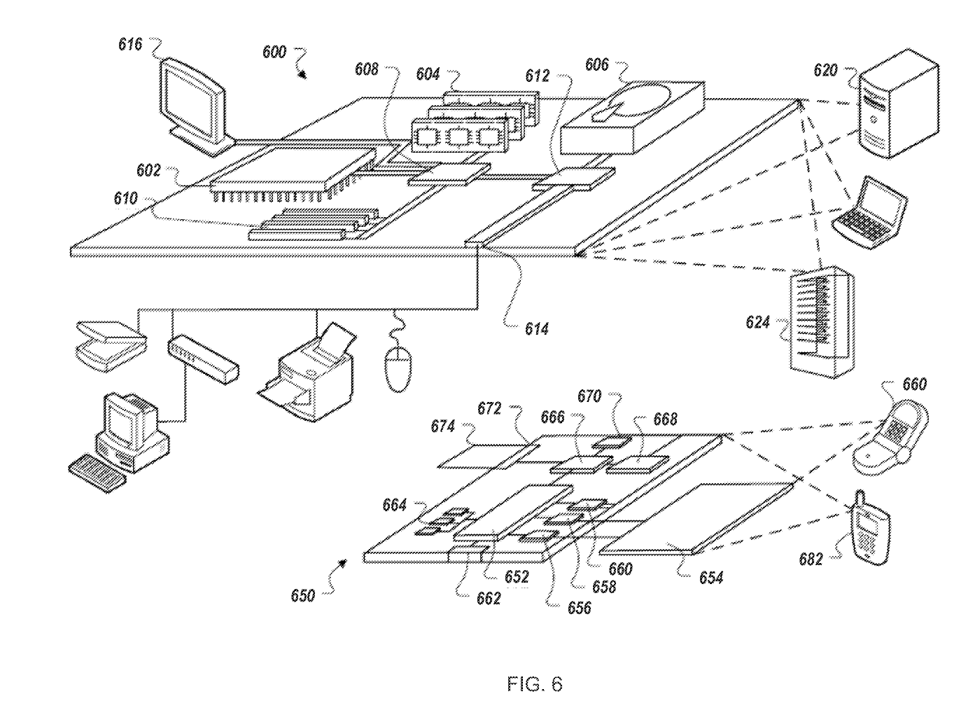

FIG. 6 shows an example of a computing device 600 and a mobile computing device 650 that can be used to implement the techniques described in this disclosure. The computing device 600 is intended to represent various forms of digital computers, such as laptops, desktops, workstations, personal digital assistants, servers, blade servers, mainframes, and other appropriate computers. The mobile computing device 650 is intended to represent various forms of mobile devices, such as personal digital assistants, cellular telephones, smart-phones, tablet computers, and other similar computing devices. The components shown here, their connections and relationships, and their functions, are meant to be examples only, and are not meant to be limiting.

The computing device 600 includes a processor 602, a memory 604, a storage device 606, a high-speed interface 608 connecting to the memory 604 and multiple high-speed expansion ports 610, and a low-speed interface 612 connecting to a low-speed expansion port 614 and the storage device 606. Each of the processor 602, the memory 604, the storage device 606, the high-speed interface 608, the high-speed expansion ports 610, and the low-speed interface 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as a display 616 coupled to the high-speed interface 608. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 604 stores information within the computing device 600. In some implementations, the memory 604 is a volatile memory unit or units. In some implementations, the memory 604 is a non-volatile memory unit or units. The memory 604 may also be another form of computer-readable medium, such as a magnetic or optical disk.

The storage device 606 is capable of providing mass storage for the computing device 600. In some implementations, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 602), perform one or more methods, such as those described above. The instructions can also be stored by one or more storage devices such as computer- or machine-readable mediums (for example, the memory 604, the storage device 606, or memory on the processor 602).

The high-speed interface 608 manages bandwidth-intensive operations for the computing device 600, while the low-speed interface 612 manages lower bandwidth-intensive operations. Such allocation of functions is an example only. In some implementations, the high-speed interface 608 is coupled to the memory 604, the display 616 (e.g., through a graphics processor or accelerator), and to the high-speed expansion ports 610, which may accept various expansion cards (not shown). In the implementation, the low-speed interface 612 is coupled to the storage device 606 and the low-speed expansion port 614. The low-speed expansion port 614, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the FIG. 6. For example, it may be implemented as a standard server 620, or multiple times in a group of such servers. In addition, it may be implemented in a personal computer such as a laptop computer 622. It may also be implemented as part of a rack server system 624. Alternatively, components from the computing device 600 may be combined with other components in a mobile device (not shown), such as a mobile computing device 650. Each of such devices may contain one or more of the computing device 600 and the mobile computing device 650, and an entire system may be made up of multiple computing devices communicating with each other.

The mobile computing device 650 includes a processor 652, a memory 664, an input/output device such as a display 654, a communication interface 666, and a transceiver 668, among other components. The mobile computing device 650 may also be provided with a storage device, such as a micro-drive or other device, to provide additional storage. Each of the processor 652, the memory 664, the display 654, the communication interface 666, and the transceiver 668, are interconnected using various buses, and several of the components may be mounted on a common motherboard or in other manners as appropriate.

The processor 652 can execute instructions within the mobile computing device 650, including instructions stored in the memory 664. The processor 652 may be implemented as a chipset of chips that include separate and multiple analog and digital processors. The processor 652 may provide, for example, for coordination of the other components of the mobile computing device 650, such as control of user interfaces, applications run by the mobile computing device 650, and wireless communication by the mobile computing device 650.

The processor 652 may communicate with a user through a control interface 658 and a display interface 656 coupled to the display 654. The display 654 may be, for example, a TFT (Thin-Film-Transistor Liquid Crystal Display) display or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may provide communication with the processor 652, so as to enable near area communication of the mobile computing device 650 with other devices. The external interface 662 may provide, for example, for wired communication in some implementations, or for wireless communication in other implementations, and multiple interfaces may also be used.

The memory 664 stores information within the mobile computing device 650. The memory 664 can be implemented as one or more of a computer-readable medium or media, a volatile memory unit or units, or a non-volatile memory unit or units. An expansion memory 674 may also be provided and connected to the mobile computing device 650 through an expansion interface 672, which may include, for example, a SIMM (Single In Line Memory Module) card interface. The expansion memory 674 may provide extra storage space for the mobile computing device 650, or may also store applications or other information for the mobile computing device 650. Specifically, the expansion memory 674 may include instructions to carry out or supplement the processes described above, and may include secure information also. Thus, for example, the expansion memory 674 may be provide as a security module for the mobile computing device 650, and may be programmed with instructions that permit secure use of the mobile computing device 650. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 652), perform one or more methods, such as those described above. The instructions can also be stored by one or more storage devices, such as one or more computer- or machine-readable mediums (for example, the memory 664, the expansion memory 674, or memory on the processor 652). In some implementations, the instructions can be received in a propagated signal, for example, over the transceiver 668 or the external interface 662.

The mobile computing device 650 may communicate wirelessly through the communication interface 666, which may include digital signal processing circuitry where necessary. The communication interface 666 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 668 using a radio-frequency. In addition, short-range communication may occur, such as using a Bluetooth, WiFi, or other such transceiver (not shown). In addition, a GPS (Global Positioning System) receiver module 670 may provide additional navigation- and location-related wireless data to the mobile computing device 650, which may be used as appropriate by applications running on the mobile computing device 650.

The mobile computing device 650 may also communicate audibly using an audio codec 660, which may receive spoken information from a user and convert it to usable digital information. The audio codec 660 may likewise generate audible sound for a user, such as through a speaker, e.g., in a handset of the mobile computing device 650. Such sound may include sound from voice telephone calls, may include recorded sound (e.g., voice messages, music files, etc.) and may also include sound generated by applications operating on the mobile computing device 650.

The mobile computing device 650 may be implemented in a number of different forms, as shown in the figure. For example, it may be implemented as a cellular telephone 680. It may also be implemented as part of a smart-phone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, systems and methods described by the present disclosure are provided for use within a closed, private internet-based network. Providing a system, service, and/or method within a closed, private internet-based network may be commonly described as providing an application appliance. The application appliance, for example, may be installed in an established location within a private network governed by the receiver of the appliance. This “appliance”, in some examples, may be delivered as a virtual machine which runs on existing virtualization infrastructure or as a physical appliance which is delivered as a piece of hardware to be installed in an existing computer network.

In view of the structure, functions and apparatus of the systems and methods described here, in some implementations, a system for distribution and amplification of information posts within community networking systems is provided. Having described certain implementations of methods and systems for amplifying and distributing electronic messages, it will now become apparent to one of skill in the art that other implementations incorporating the concepts of the disclosure may be used. Therefore, the disclosure should not be limited to certain implementations, but rather should be limited only by the spirit and scope of the following claims.

1. A method comprising:
identifying, by a processor of a computing device, a message for sharing with a plurality of members of an organization, wherein the message is associated with the organization;
distributing, by the processor, to each member of the plurality of members, an offer to share the message;
receiving, by the processor, responsive to the offer to share, from at least a portion of the plurality of members, a respective authorization to share the message via a networking community;
causing, by the processor, issuance of the message via the networking community on behalf of each member of the portion of the plurality of members;
after causing issuance of the message, receiving, by the processor, an indication of one or more engagements with the message;
storing, by the processor, collected information regarding the one or more engagements, wherein the collected information regarding the one or more engagements comprises one or more of a timestamp, a region, a networking community, a networking community account identifier, and text content of the engagement;
preparing, by the processor, a report comprising the collected information regarding the one or more engagements; and
providing the report for review by the organization.

2. The method of claim 1, wherein:
each engagement of the one or more engagements comprises one or more of a click-through, a re-post, a share, a like, a retweet, and a comment referencing the message; and
each engagement of the one or more engagements is associated with an individual not included in the portion of the plurality of members.

3. The method of claim 1, wherein the click-through comprises access to a customized link to a Uniform Resource Identifier.

4. The method of claim 1, wherein causing issuance of the message comprises distributing the message via a networking community application programming interface.

5. The method of claim 1, wherein distributing the offer to share comprises posting information to one or more members of the plurality of members via the networking community.

6. The method of claim 1, wherein causing issuance of the message comprises scheduling the message for issuance using a scheduling algorithm, wherein the scheduling algorithm is based in part upon historical analysis of message sharing.

7. The method of 6, wherein scheduling the message comprises:
scheduling the message to issue at a first time for a first group of the portion of the plurality of members; and
scheduling the message to issue at a second time for a second group of the portion of the plurality of members.

8. The method of claim 6, further comprising:
identifying, based in part upon the collected information, one or more time periods most prevalent for engagement of messages, and
updating the scheduling algorithm according to the one or more time periods.

9. The method of claim 8, wherein identifying the one or more time periods further comprises identifying one or more time periods per day.

10. The method of claim 1, wherein:
receiving the indication of one or more engagements of the message comprises receiving the indication of one or more engagements of the message as issued on behalf of a particular member of the plurality of members, wherein
the method further comprises, responsive to receiving the indication of one or more engagements of the message as issued on behalf of the particular member, crediting an account associated with the particular member with a number of engagements.

11. The method of claim 1, further comprising:
storing collected information regarding authorizations to share, wherein
the method further comprises, prior to distributing the message, scheduling the message for distribution, wherein the message is scheduled based upon a distribution algorithm, wherein
the distribution algorithm is based in part upon prior collected information regarding authorizations to share.

12. The method of claim 11, further comprising:
identifying, based in part upon the collected information regarding authorizations to share, one or more time periods most prevalent for sharing messages, and
updating the distribution algorithm according to the one or more time periods most prevalent for sharing messages.

13. A system comprising:
a processor; and
a memory having instructions stored thereon, wherein the instructions, when executed by the processor, cause the processor to:
retrieve, from a network account associated with an organization, a plurality of messages;
identify, within the plurality of messages, a first message for distribution to a plurality of members of the organization;
distribute, to each member of the plurality of members, an offer to share the message via one or more networking community accounts associated with the respective member;
receive, responsive to the offer to share, from at least a portion of the plurality of members, a respective authorization to share the message, wherein the respective authorization identifies at least one of the one or more respective networking community accounts;
for each member of the portion of the plurality of members, cause issuance of the message via the respective at least one of the one or more respective networking community accounts;
after causing issuance of the message, collect information related to the distribution of the message, wherein the information is collected via application programming interfaces provided by one or more networking community entities associated with the respective networking community accounts; and
determine statistical information regarding the information related to the distribution of the message.

14. The system of claim 13, wherein identifying the first message comprises identifying, within the first message, a predetermined mark.

15. The system of claim 14, wherein the predetermined mark comprises a hashtag.

16. The system of claim 13, wherein identifying the first message comprises filtering the plurality of messages to identify a portion of the plurality of messages containing content originated by the organization.

17. The system of claim 16, wherein identifying the first message further comprises filtering the plurality of messages to remove messages identified by a predetermined criteria.

18. The system of claim 13, wherein the network account comprises one of a social media account, RSS feed, and blog feed.

19. A non-transitory computer readable medium having instructions stored thereon, wherein the instructions, when executed by a processor, cause the processor to:
identify a message for distribution to a plurality of members of an organization, wherein the message is associated with the organization;
distribute, to each member of the plurality of members, an offer to share the message via one or more social media accounts associated with the respective member;
receive, responsive to the offer to share, from at least a portion of the plurality of members, a respective authorization to share the message, wherein the respective authorization identifies at least one of the one or more respective social media accounts;
for each member of the portion of the plurality of members, cause issuance of the message via the respective at least one of the one or more respective social media accounts;
after causing issuance of the message, receive a plurality of indications of engagements of the message, wherein at least a portion of the plurality of indications of engagements comprises a member identifier;
determine information regarding the engagements of the message, wherein
the information regarding the engagements of the message comprises one or more of a timestamp, a region, and a networking community, a networking community account identifier, and text content of the engagement; and
the information regarding the engagements of the message is made available for review by the organization; and
for each respective member identifier, credit an account with the respective number of engagements.

20. The computer readable medium of claim 19, wherein the instructions further cause the processor to receive, from a first member of the portion of the plurality of members, responsive to the offer to share, a customized version of the message, wherein causing issuance of the message comprises causing issuance of the customized message.

21. The computer readable medium of claim 20, wherein the instructions further cause the processor to, prior to receiving the customized version of the message:
determine permission settings of the first member; and
provide, based in part upon the permission settings of the first member, an interactive dialogue comprising the message, wherein the first member amends or alters the first message within the interactive dialogue.
